(19) United States
(12) Patent Application Publication
(10) Pub. No.: US 2005/0212856 A1
(43) Pub. Date: Sep. 29, 2005

(54) Fluid pumping and droplet deposition apparatus

(76) Inventors: Stephen Temple, Cambridge (GB); Robert Harvey, Cambridge (GB); Ronald Zmood, Caulfield North (AU); Robert J. Lowe, Cambridge (GB); Paul R. Drury, Royston Hertfordshire (GB)

Correspondence Address: MARSHALL, GERSTEIN & BORUN LLP, 233 S. WACKER DRIVE, SUITE 6300, SEARS TOWER, CHICAGO, IL, 60606, US

(21) Appl. No.: 10/505,461

(22) PCT Filed: Feb. 20, 2003
(86) PCT No.: PCT/GB03/00739

§ 371 Date: Apr. 8, 2005

(30) Foreign Application Priority Data
Feb. 20, 2002 (GB) 0204010.3

(51) Int. Cl. B41J 2/135

(52) U.S. Cl. 347/46

(57) ABSTRACT

In a fluid pumping apparatus suitable for use in drop on demand ink jet printing, a resiliently deformable chamber wall is acted upon to create acoustic waves, which in turn cause a fluid flow in a chamber outlet. The resiliently deformable chamber wall preferably includes both rigid and flexible portions. In an alternative arrangement a channel wall is provided with a region moveable in an actuation direction. An electromagnetic actuator operates under the principle of flux modulation. The invention is preferably of planar construction, manufactured using MEMS techniques.

The present invention relates to fluid pumping apparatus and in particular to droplet deposition apparatus suitable for drop on demand ink jet printing.

Fluid pumping and particularly miniature fluid pumping apparatus has a number of commercially important applications including the dispensing of drugs, and in a particular example, apparatus for producing an aerosol. It is an object of the present invention to seek to provide an improved fluid pumping apparatus and an improved fluid pumping actuator.

A fluid pumping application of particular interest is printing. Digital printing and particularly inkjet printing is quickly becoming an important technique in a number of the global printing markets. It is envisaged that pagewide printers, capable of printing over 100 sheets a minute, will soon be commercially available.

Inkjet printers today typically use one of two actuation methods. In the first, a heater is used to boil the ink thereby creating a bubble of sufficient size to eject a corresponding droplet of ink. The inks for bubble jet printers are typically aqueous and thus a large amount of energy is required to vapourise the ink and create a sufficient bubble. This tends to increase the cost of the drive circuits and also reduces the life time of the printhead.

The second actuation method uses a piezoelectric component that deforms upon actuation of an electric field. This deformation causes ejection either by a pressure increase in a chamber or through creation of an acoustic wave in the channel. The choice of ink is significantly wider for piezoelectric printheads as solvent, aqueous, hot melt and oil based inks are acceptable.

It is a further object of the present invention to seek to provide an improved droplet deposition apparatus and an improved droplet deposition actuator.

According to one aspect of the present invention there is provided fluid pumping apparatus comprising chamber walls defining a liquid chamber, one of said chamber walls being resiliently deformable in an actuation direction; a chamber outlet, and an actuator remote from the chamber, acting in said actuation direction upon said resiliently deformable channel wall to create acoustic waves in the chamber and thereby cause fluid flow in the chamber outlet.

In a second aspect of the present invention there is provided droplet deposition apparatus comprising chamber walls defining a liquid chamber, one of said chamber walls being resiliently deformable in an actuation direction; an ejection nozzle connected with the chamber; a liquid supply providing for continuous flow of liquid through the chamber; acoustic boundaries serving to reflect acoustic waves in the liquid of the chamber, and an actuator remote from the chamber and the liquid supply, acting in said actuation direction upon said resiliently deformable chamber wall to create acoustic waves in the liquid of the chamber and thereby cause droplet ejection through said nozzle.

The resiliently deformable chamber wall, preferably located in a wall opposite to that containing the nozzle forms a liquid seal isolating the actuator from fluid in the channel. The deformable wall may be a common sheet between the actuator and a walled component.

The resiliently deformable chamber wall preferably comprises a substantially rigid element capable of transmitting force from the actuator to fluid in the channel and at least one flexure element. The flexure elements constrain the movement of the rigid element to the actuation direction and are preferably stiff with respect to the liquid pressure. A parallelogram linkage to the rigid element has been found to be particularly appropriate and where the actuator comprises a push-rod this can act directly and indeed can be carried upon the rigid element.

In a particularly suitable arrangement, the fluid chamber comprises an elongate liquid channel having a resiliently deformable channel wall, wherein the flexure element can extend across either the full width or over a portion of the wall. In such an arrangement the rigid element typically extends along the length of the channel, and actuation is in a direction orthogonal to the channel length to resiliently deform an elongate channel wall in the actuation direction.

The actuator itself may be any appropriate device, however, in a preferred embodiment of the actuator the push-rod serves as the armature in an electromagnetic actuator arrangement and in a particularly preferred embodiment the armature is displaced through a modulation of a flux.

In this particularly preferred embodiment the armature is displaced along said actuation direction and a flux of substantially constant magnitude is disposed in air gaps abutting the armature in flux paths spaced apart in the actuation direction. The flux modulation serves to distribute the flux in the air gaps to generate force on the armature and thus movement.

A primary magnet (preferably a permanent magnet) is provided to establish a flux and a secondary magnet (preferably an electromagnet) serves to modulate the distribution of said flux. Neither the primary magnet nor the secondary magnet operating alone need achieve the desirable force-displacement characteristics of the armature, provided for by the superposition of the two magnetic fields.

A stator component can be provided that comprises a slot into which the coil of an electromagnet is disposed, the slot opening to said air gaps. The coil is arranged coaxial with the actuation direction in some embodiments, or with its axis perpendicular to the actuation direction in other embodiments.

Preferably, said modulation in distribution of a flux comprises an increase in flux density at a first air gap and a decrease in flux density at a second air gap, the first and second air gap locations being spaced in the actuation direction.

Advantageously, said increase in flux density at a first air gap and a decrease in flux density at a second air gap, is achieved through constructive and destructive interference, respectively between a switchable magnetic field and a constant magnetic field.

It is preferred that the actuator is formed via a Micro-Electro Mechanical-Systems (MEMS) technique in which a (usually) silicon wafer undergoes repeated formation and selective removal of layers, using etching, deposition and similar techniques originating in integrated circuit manufacturing techniques.

In a further aspect of the present invention, there is provided droplet deposition apparatus comprising an elongate liquid channel capable of sustaining acoustic waves travelling in the liquid along the length of the channel, a droplet ejection nozzle positioned for the ejection of a droplet in response to said acoustic waves and an electromagnetic actuator serving on receipt of an electrical drive signal to create an acoustic wave in the channel and thereby effect droplet ejection.

In an embodiment comprising an elongate channel, acoustic boundaries are suitably located at respective opposing ends of the channel and serve to reflect acoustic waves in the liquid of the channel. These reflections are preferably negative reflections.

In a droplet deposition apparatus configured according to an aspect of the invention, an ejection nozzle is preferably connected with the channel at a point intermediate its length and a liquid supply provides for continuous flow of liquid along the channel. One of the acoustic boundaries may be a wall, comprising a nozzle. In this situation only one liquid supply is provided in the liquid chamber, typically located at the opposite end of the chamber to the nozzle.

It has been found that certain embodiments of the present invention can advantageously be constructed from planar components, which components can then be assembled parallel to each other. Processes suitable for forming such planar components include etching, machining and electroforming.

In another aspect of the present invention there is provided a generally planar component for use in fluid pumping apparatus comprising:
a first planar layer having resiliently deformable portions;
a second planar layer parallel to said first layer having corresponding resiliently deformable portions; and
a plurality of actuators having an actuation direction, located between said two layers and connected to interior surfaces of said two layers with the direction of actuation orthogonal to the two layers;
   wherein said actuators are operable to deform selected resiliently deformable portions of said first and second layers in an actuation direction so as to cause a change in pressure of a liquid in contact with the exterior of said first planar layer.

The first layer is desirably continuous and impermeable, while the second layer may comprise a number of individual portions of material, and may be permeable.

In a preferred arrangement, the actuators comprise rigid push rods, which are in turn connected between corresponding deformable portions of the two layers. In one embodiment of this arrangement the push rods are constrained by the two layers to move only in the actuation direction.

According to a related aspect of the invention there is provided a method of constructing a fluid pumping apparatus comprising the steps of forming a first planar component as described above, and forming a second planar component comprising a plurality of rigid channel walls defining open sided channels corresponding to the resiliently deformable portions of said first planar component; and mating the two planar components such that they are parallel and such that the channels of the second planar component are aligned with the resiliently deformable portions of the first planar component, which thus form part of a resiliently deformable channel wall.

In another aspect of the invention, there is provided fluid pumping apparatus comprising elongate channel walls defining an elongate fluid channel, the channel having a fluid outlet, one of said channel walls having at least one distinct region movable in translation in an actuation direction orthogonal to the length of the channel and at least one straight line actuator acting in said actuation direction upon said region of the channel wall to create an acoustic wave in the channel and thereby expel fluid from said outlet.

Preferably the straight line actuator comprises an armature movable bodily under electromagnetic force in a straight line in the actuation direction.

In a further aspect of the present invention, there is provided droplet deposition apparatus comprising an elongate liquid channel bounded in part by a resiliently deformable diaphragm; a liquid supply for the channel; an ejection nozzle communicating with the channel; and a push-rod which is separated from the liquid by the diaphragm, the push-rod being displaceable in an actuation direction orthogonal to the length of the channel to deform the diaphragm to displace liquid in the channel and thereby cause droplet ejection through said nozzle, wherein the push-rod is supported by at least one flexural element at two locations spaced one from the other in the actuation direction.

In a further aspect of the present invention, there is provided a method of manufacturing droplet deposition apparatus, having a first planar component comprising a plurality of rigid channel walls corresponding with a set of parallel channels; a resiliently deformable channel wall for each channel, said resiliently deformable channel walls lying in a common plane; and a second planar component comprising a linear actuator for each channel, said actuators having respective actuation directions which are parallel; the resiliently deformable channel walls lying between and in a parallel relationship with the first and second planar components in the manufactured apparatus, with said actuation direction disposed orthogonal to said common plane and the actuators serving to actuate the respective channels through deformation of the associated resiliently deformable channel walls.

The invention will now be described, by way of example only, with respect to the following drawings in which:

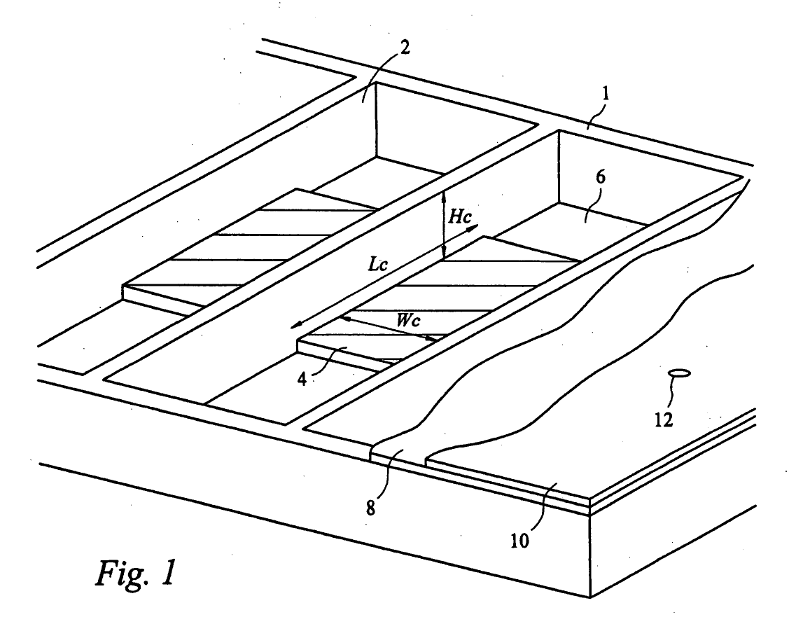

FIG. 1 depicts in perspective a view from underneath a channelled component according to one embodiment of the present invention;

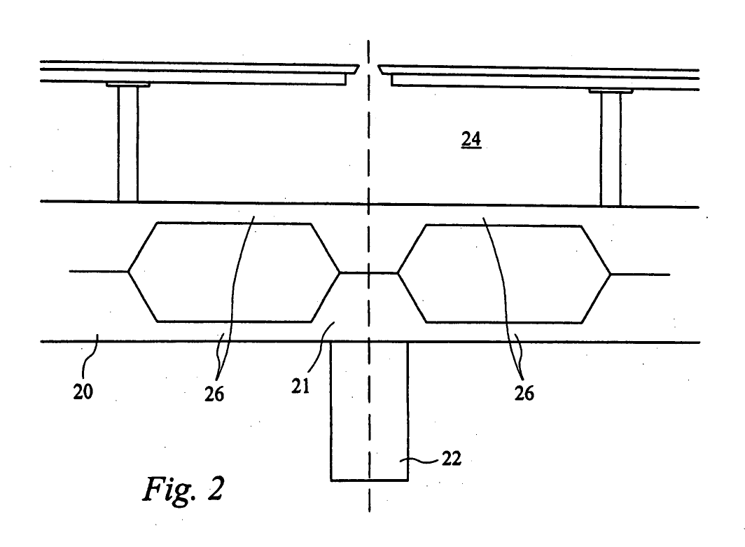

FIG. 2 depicts in sectional view a printhead according to a second embodiment of the present invention;

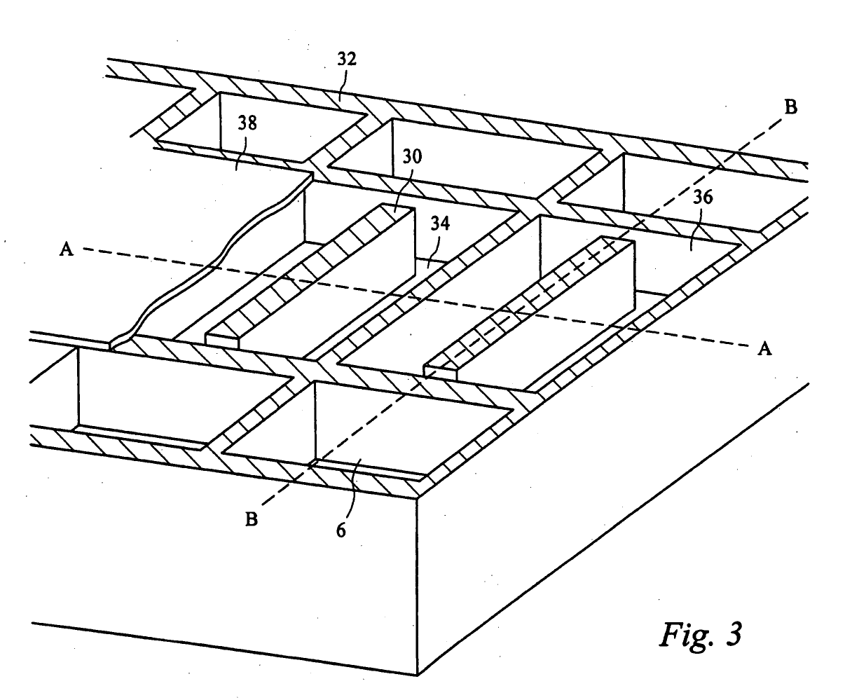

FIG. 3 shows in perspective under view printhead according to a further embodiment of the present invention;

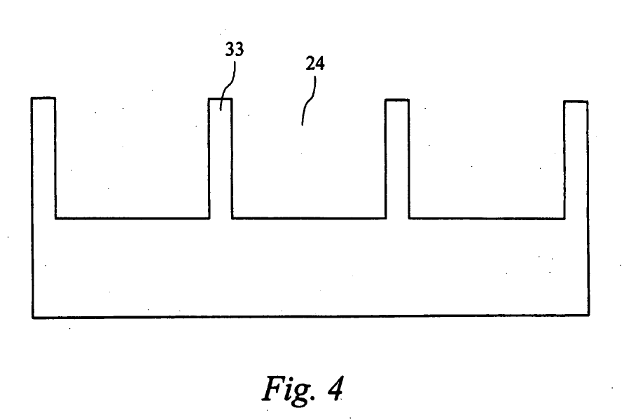

FIGS. 4 to 11 depict in respective sectional views steps in the manufacture of the printhead shown in FIG. 3;

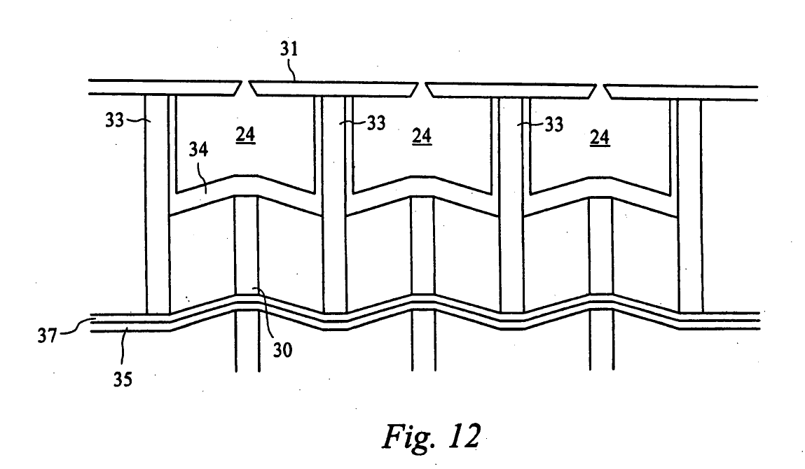

FIG. 12 depicts in sectional view the actuation of the printhead shown in FIG. 3;

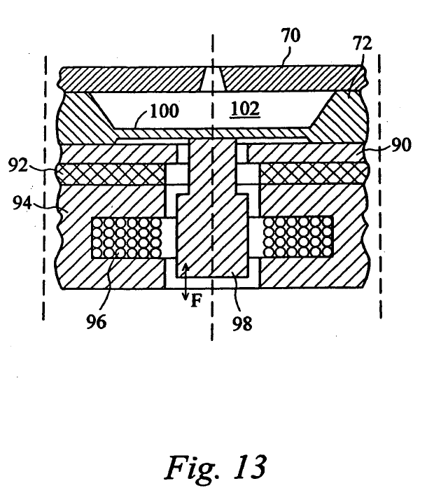

FIG. 13 is a flux modulation actuator in a printhead according to an embodiment of the present invention;

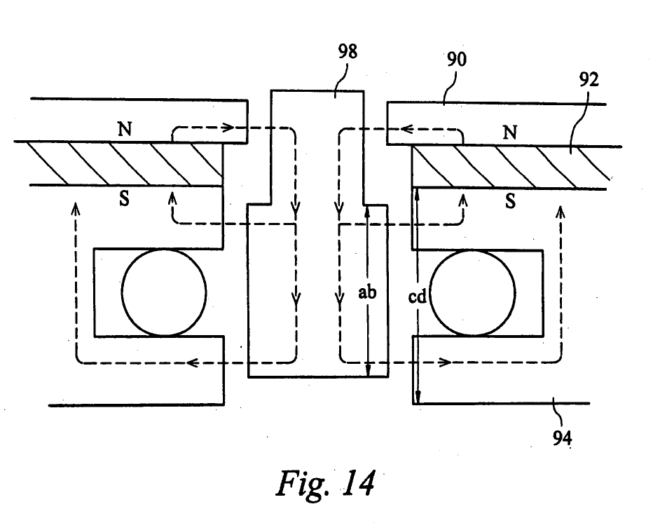

FIG. 14 is an expanded view of the flux modulation actuator of FIG. 13 showing field lines;

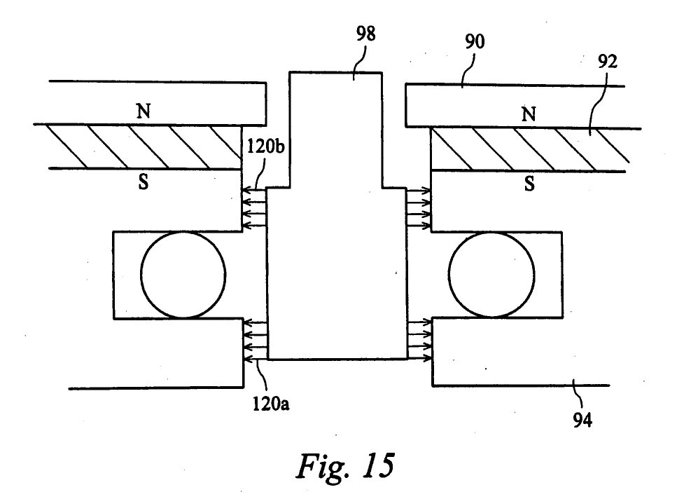

FIGS. 15 to 17 are views similar to FIG. 14 respective orientations adopted by the actuator in use;

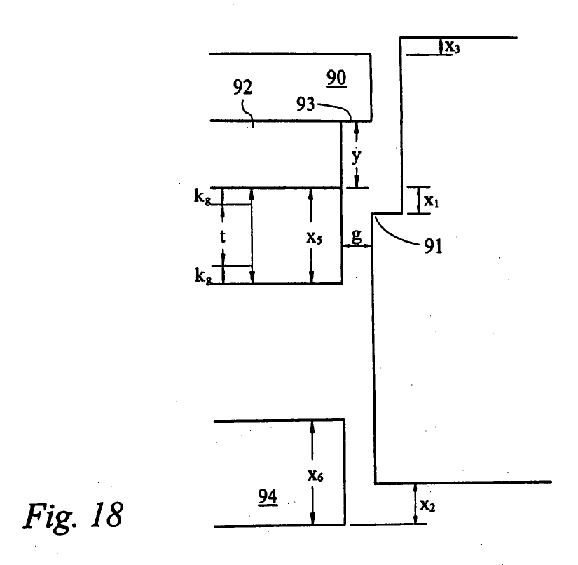

FIG. 18 depicts key dimensions in the arrangement of the bias flux actuator;

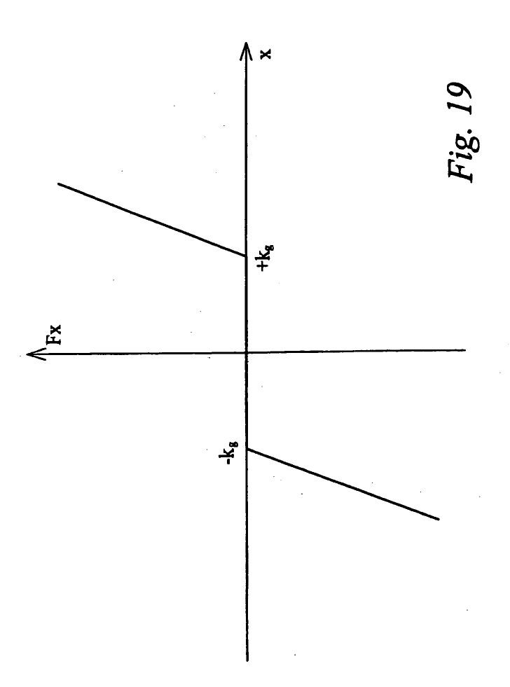

FIG. 19 is a graph showing Fₓ vs x for the bias flux actuator with i=0;

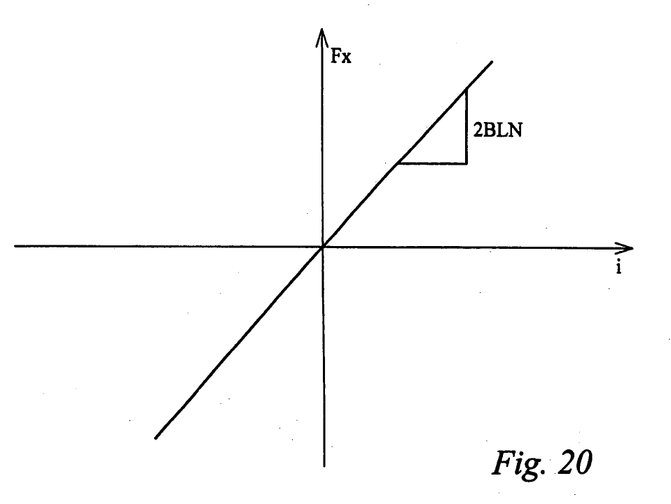

FIG. 20 is a graph of Fₓ vs i for the range −kg<x<+kg;

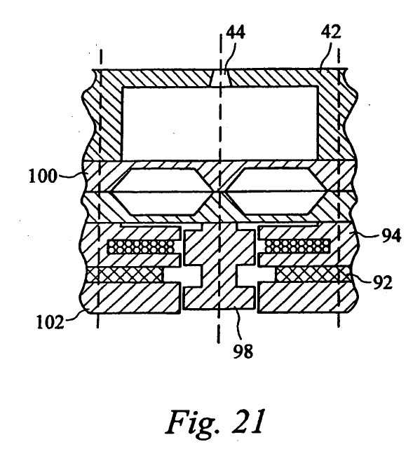

FIG. 21 depicts a flux modulation actuator coupled to an ejection chamber via a push-rod spacer plate;

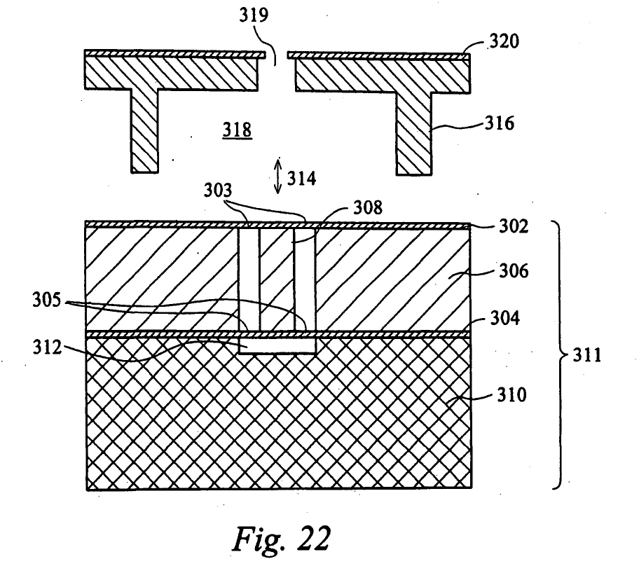

FIG. 22 illustrates a generic planar construction of a fluid pumping apparatus according to one embodiment of the invention;

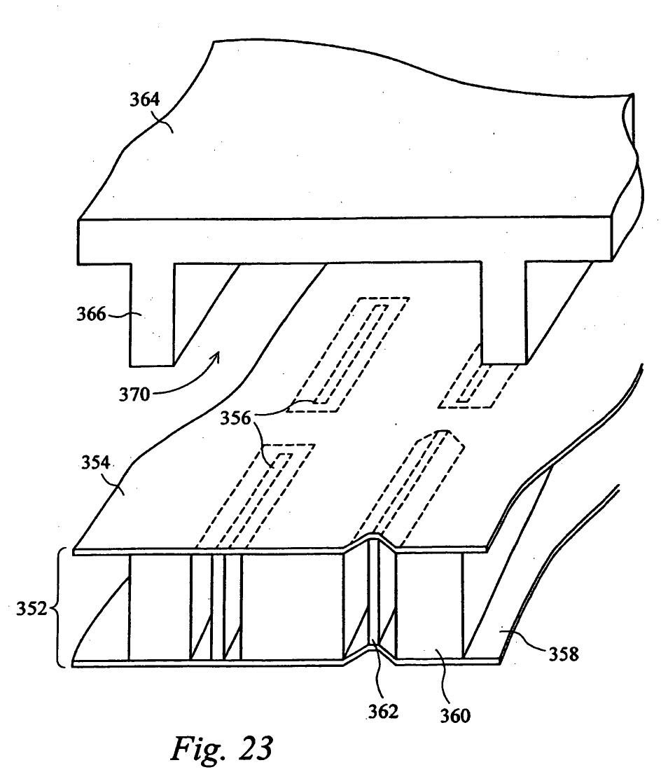

FIG. 23 shows a view of a channelled construction for use in a fluid pumping apparatus according to one embodiment of the invention;

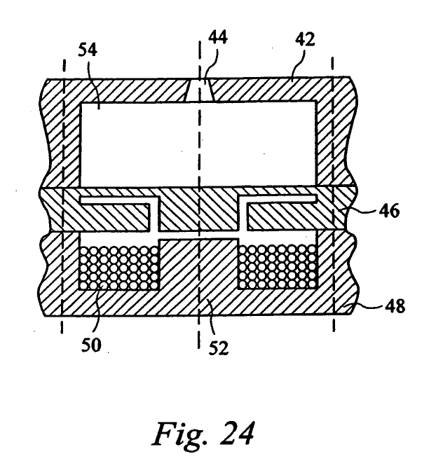

FIG. 24 shows a variable reluctance type magnetic actuator in a printhead according to an embodiment of the present invention;

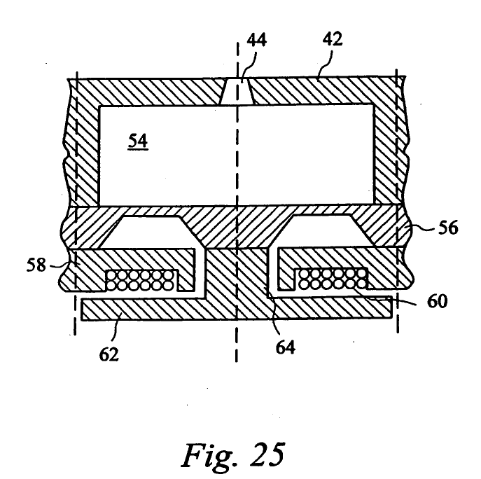

FIG. 25 depicts in a similar view an alternative type variable reluctance type magnetic actuator;

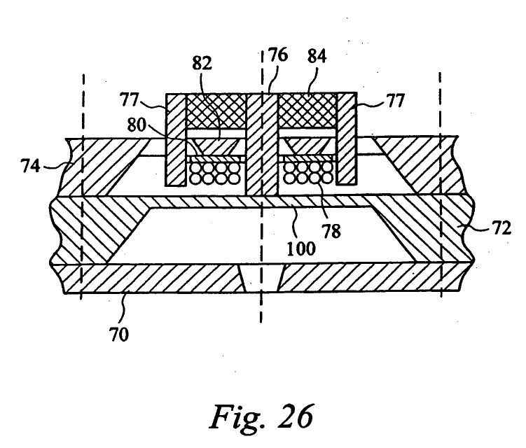

FIG. 26 shows a Lorenz force actuator in a printhead according to an embodiment of the present invention;

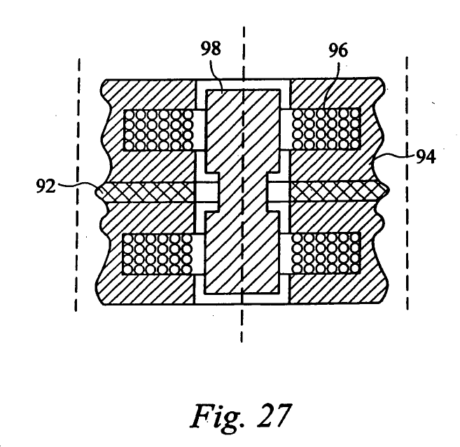

FIG. 27 depicts an alternative actuator arrangement;

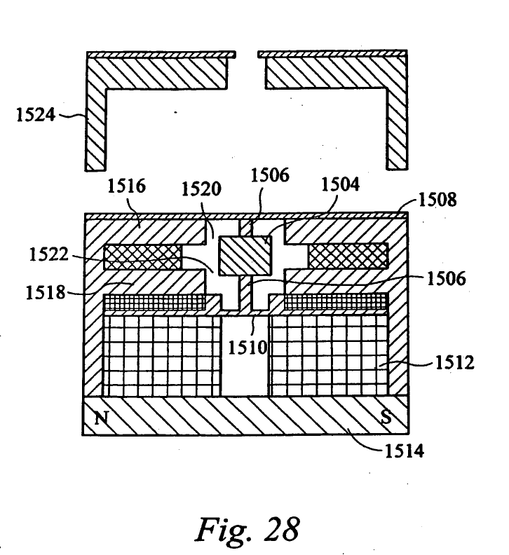

FIGS. 28 to 31 illustrate further alternative actuator arrangements; and

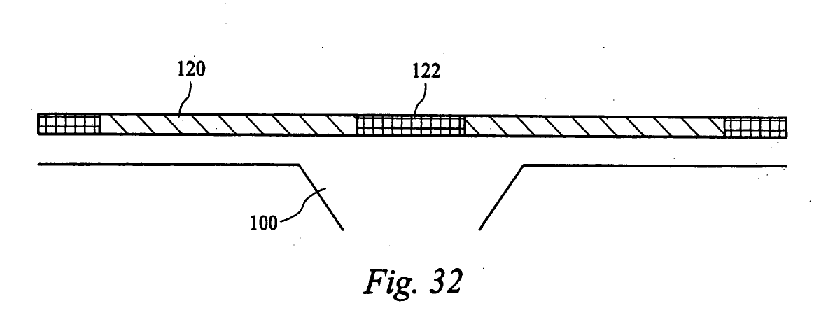

FIGS. 32 to 40 depict steps in the manufacture of the actuator shown in FIG. 21.

One of the benefits of certain aspects of the present invention is that the printhead itself can be formed from a number of individually manufactured components. The first component comprises the actuator element whilst a second component comprises the channel structure. Other features may be manufactured as separate components or may be formed as part of the components above.

FIG. 1 depicts the channelled component in one embodiment of the invention. A sheet of silicon, ceramic or metallic material 1 is etched, machined or electroformed as appropriate to form a plurality channels, separated by walls 2, extending the length of the component. The component comprises a resiliently deformable wall 4 that extends part of the way along the channel. The wall forms the base of the ejection chamber and is deformed by an actuator (not shown), remote from the channel, acting on its reverse side. At either end of the resiliently deformable wall through ports 6 are provided that act to supply ejection fluid to the completed actuator.

A cover component 8 of a Nickel/Iron alloy, such as Nilo42, is attached to the top surface of the channelled component and comprises through ports for alignment with nozzle orifices 12 located in a nozzle plate 10.

The width W_{c}, Height H_{c}, and Length L_{c} of the ejection chamber have dimensions that satisfy the conditions W_{c}, H_{c}<<L_{c}. The acoustic length L_{c} being determined from the operating frequency and the speed of sound in the chamber and is typically of the order 2 mm. The nozzle is positioned mid-way along the chamber and each end of the chamber opens into the manifold formed by the through ports 6.

In operation, the manifolds can either both supply ink to the chamber or the supply arrangement can be such that ink can continually be circulated through the chamber, one of the manifolds returning the excess and unprinted fluid to a reservoir.

The open ends of the chamber provide an acoustic boundary that negatively reflect the acoustic waves in the channel. These reflected waves converge at the nozzle and cause droplet ejection. Thus, the manifolds must have a large cross-sectional area with respect to the size of the channel in order to achieve an appropriate boundary.

The resiliently deformable wall 4 comprises a directly or indirectly attached actuator element. The actuator element is positioned on the opposite side of the resiliently deformable wall to that facing the nozzle and is thus located remote from the ejection chamber. The actuator moves in a straight line to cause the deformable wall to deflect orthogonally with respect to the direction of chamber length to generate the acoustic waves. The initial direction of movement can be either towards or away from the nozzle.

By repeatedly actuating the deformable wall in quick succession it becomes possible to eject a number of droplets in a single ejection train. These droplets can combine either in flight or on the paper to form printed dots of different sizes depending on the number of droplets ejected.

In FIG. 2, a more complex silicon floor plate 20 is used to transmit the force of the actuator element 22 to the ejection chamber 24 rather than the simple flat diaphragm 4 of FIG. 1. The plate 20 is formed from two etched silicon wafers bonded together by adhesive or other standard silicon wafer bonding methods and performs two functions. In the first instance it needs to support the actuator and provides a restoring force to bring the actuator back to its steady state rest position as well as to prevent bending forces and moments on the plate from being transmitted to the actuator.

In the second instance the floor plate must be sufficiently stiff so that the volumetric compliance due to changes in ink pressure is low otherwise the acoustic velocity in the ink will be adversely affected.

The floor plate can be seen as effectively forming a parallelogram linkage comprising flexure elements 26 with respect to a rigid element 21, the actuator acting directly onto the rigid element.

The usefulness and benefits of such a floor plate will later be described in greater detail with regard to FIG. 21.

Whilst, in the example of FIG. 2, the floor plate is considered to be a separate plate, it is equally possible to form it as part of the channelled component as will be described with reference to FIG. 3.

The channels are at the underside of the component as seen in FIG. 3 and are not visible.

Push-rods 30 are formed integrally with the floor 34 of the ejection chamber. A base plate 38 is attached to the component such that it extends over the upstanding walls 32 and isolates the push-rods and the push-rod chamber 36. This base plate is flexible, thus providing a flexible linkage for the end of the push-rod remote from the ejection chamber.

The manufacture of the channelled component of FIG. 3 is preferably achieved by a mixture of wet etching and deep reactive ion etching (DRIE). A silicon plate is provided and, as shown in FIG. 4, is etched from one surface using DRIE to form the ejection chambers 24 and walls dividing the ejection chambers 33.

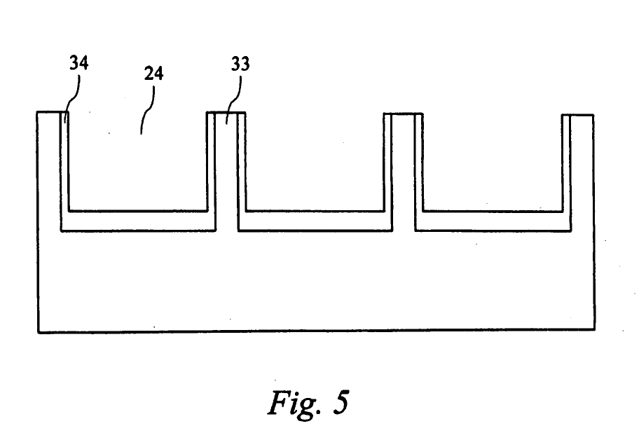

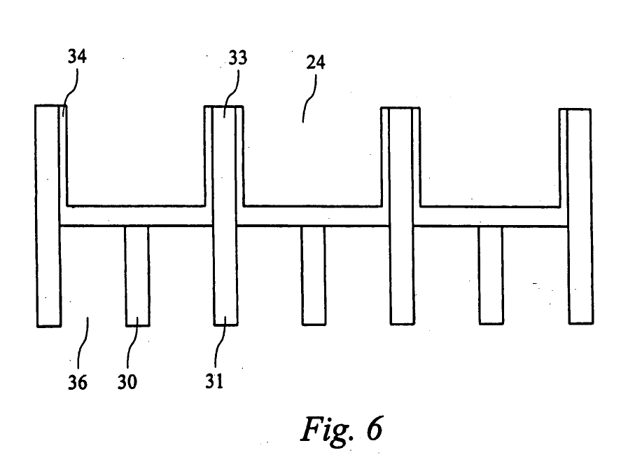

At a predetermined depth etching is halted and an etch stop layer 34 of silicon dioxide and/or silicon nitride is deposited over the surface of the ejection chamber as depicted in FIG. 5. From the opposite side, by DRIE, the pusher rod 30 and dividing walls 31 are formed with the etchant removing silicon to the previously formed SiO₂ and/or SiN layer 34. Because this layer is not removed a thin flexible membrane, as in FIG. 6, remains to separate the ejection chamber from the pusher rod chamber 36.

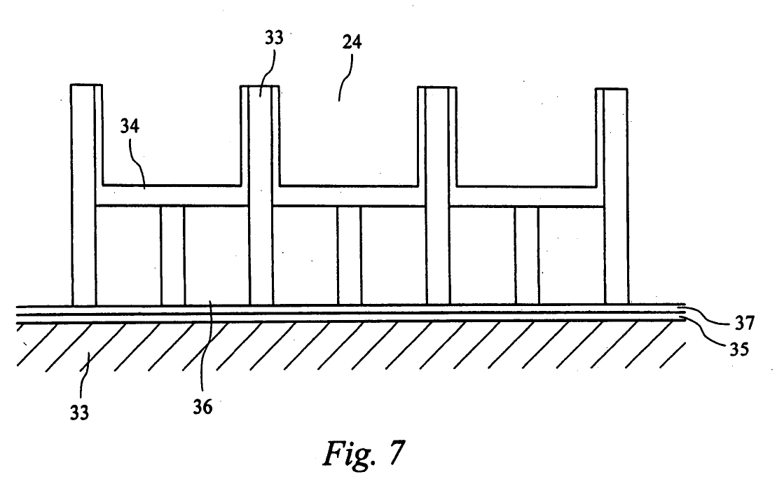

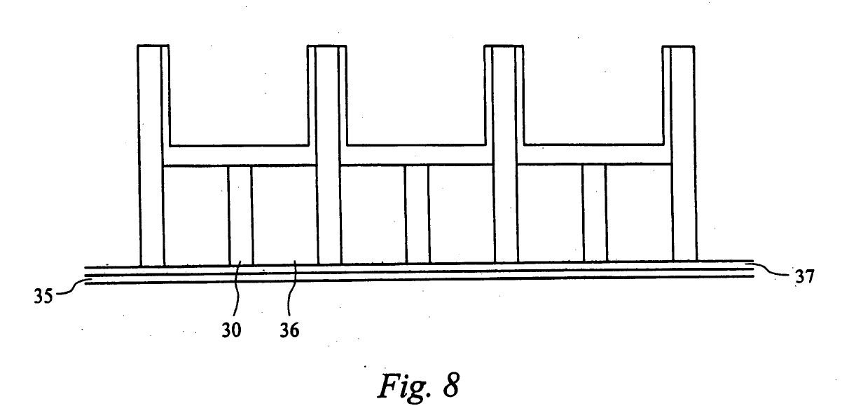

In FIG. 7, a second silicon plate 33 is bonded to the side of the first plate comprising the pusher rod chamber 36. This second plate has a two layer coating, namely SiO₂ 35 overlaid with a coating of SiN 37, with the SiN preferably extending over a greater area of the second plate than the SiO₂. The second silicon plate 33 is a sacrificial layer that is subsequently removed by wet etching to leave a flexible membrane of SiN and SiO₂ as depicted in FIG. 8.

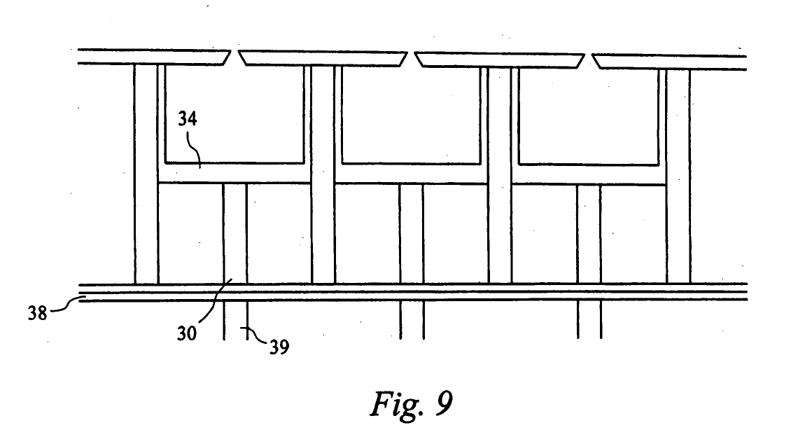

As in FIG. 9, an actuator (depicted schematically through armature 39) can then be formed on the SiN and SiO₂ membrane using MEMS fabrication techniques. (This process is later described in greater detail with respect to FIGS. 32 to 40.) The final steps are to remove the SiN or SiO₂ layer that remains in the ink supply ports 6 and to apply cover and nozzle plates.

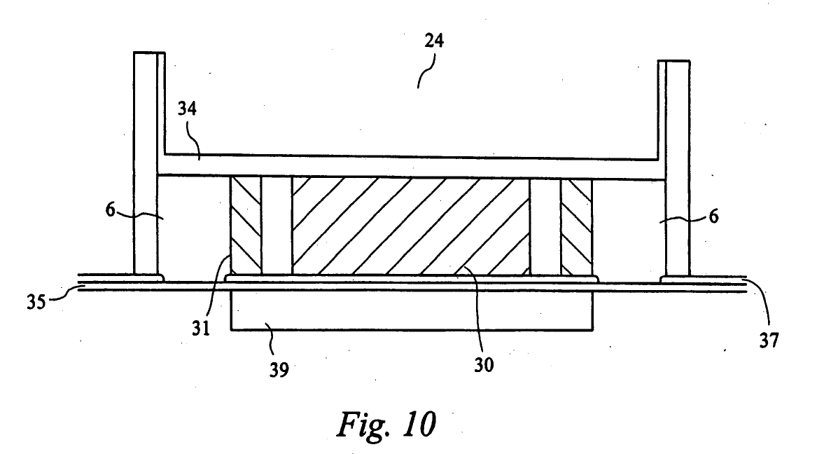

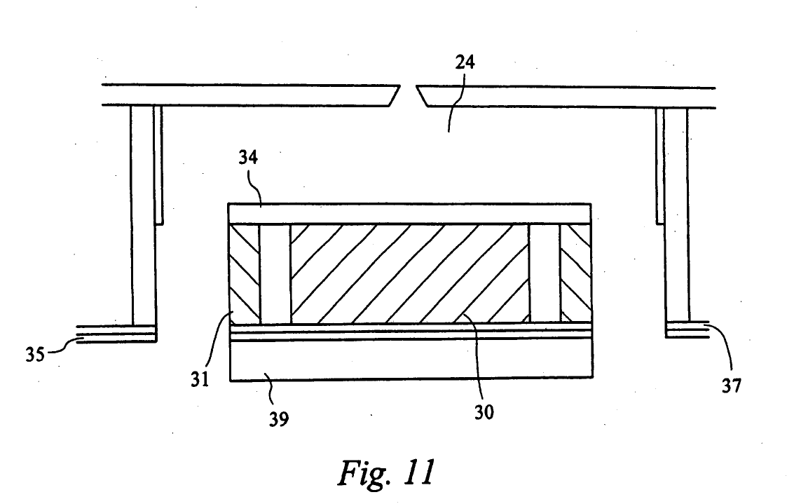

FIG. 10 is a view along line B-B of FIG. 3 before the membranes 34 and 35,37 within the ink supply ports 6 are removed. These are removed, preferably by wet etching, to open up the supply ports and allow ink to flow along the ejection chamber. A cover plate is added in FIG. 11.

FIG. 12 shows the cross sectional view across line A-A of FIG. 3. The ink channel 24 is bounded on one side by the resiliently deformable channel wall 34, a nozzle plate 31 forming the wall opposed the resiliently deformable channel wall and two rigid non-deformable walls 33.

The pusher-rod 30 is positioned in a chamber located between the resiliently deformable wall and the resiliently deformable base plate 35,37. An actuator is positioned such that an armature 39 acts on the opposite side of the resiliently deformable base plate to the pusher rod.

As the actuator acts on the pusher-rod, both the resiliently deformable floor plate and the resiliently deformable base plate are deformed. In certain circumstances it is desirable that the stiffness of the two resiliently deformable plates is chosen to be different. However, it is equally sufficient that the two resiliently deformable plates are of the same stiffness.

It has also been depicted that the walls 33 bounding the ejection chambers 24 and the walls 35 bounding the pusher-rod 36 chamber are of equal thickness. However, according to particular resiliency of the deformable walls it is sometimes desirable to alter the thicknesses of the walls 33, 35 such that one is thicker than the other.

The actuator, which may include the resiliently deformable base plate, is preferably attached as a plate structure. A preferred method of construction is described later with respect to FIGS. 32 to 40.

As mentioned earlier, the actuator is formed distinct from the channelled component and therefore a number of different types of actuator are appropriate for use with the above described channelled component. The present invention is in certain embodiments particularly concerned with electromagnetic actuators and with new types of electromagnetic actuators preferably manufactured by a MEMS technique.

The preferred magnetic actuator is described with respect to FIG. 13. This actuator can be defined as a slotted stator actuator that is deflected by modulating the air gap magnetic bias flux field distribution. The actuator armature 98 moves in the direction of arrow F and pushes against a diaphragm 100 to induce a pressure disturbance, and hence an acoustic wave, in the ink within the ink chamber 102.

The actuator component consists of a permanent magnet 92 that lies between a slotted stator plate 94 and the flux actuator plate 90. The slot of the slotted stator plate contains a multi-turn excitation coil 96. This coil, when excited with a DC current, generates a constant axial force F on the shaped armature 98. Beneficially, the magnitude of the force F is directly proportional to the magnitude of the current i.

FIGS. 14 to 17 depict the actuating principle of the actuator. FIG. 14 shows the path of the field lines from the permanent magnet. As shown in FIG. 15, when no current is flowing through the coil the field strengths 120a, 120b are similar at both pole faces of the slotted stator 94. This is achieved by making the armature pole face ‘ab’ shorter than the stator pole face ‘cd’.

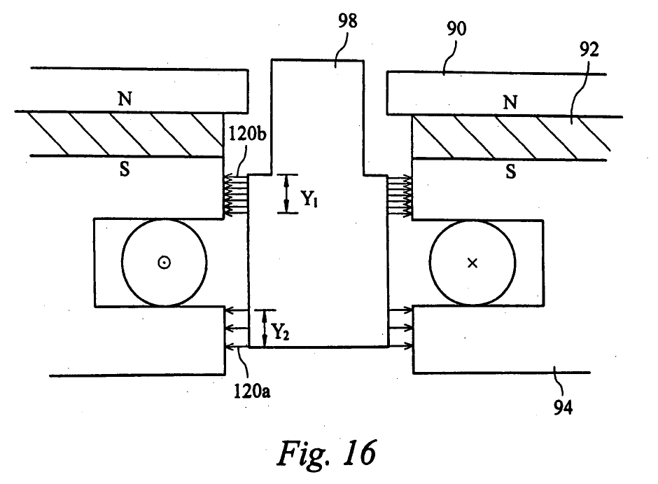

When a DC current is passed through the coil the flux lines and field strength are distorted as depicted in FIG. 16. Using the equation:
W=∫½B²/μdV
where W is the total energy of the system, B is the flux density in the air gap, μ₀ is the magnetic permeability of free space and V is airgap volume, it can be seen that, because B is squared, the total energy in the system is greater in FIG. 16 than in FIG. 15.

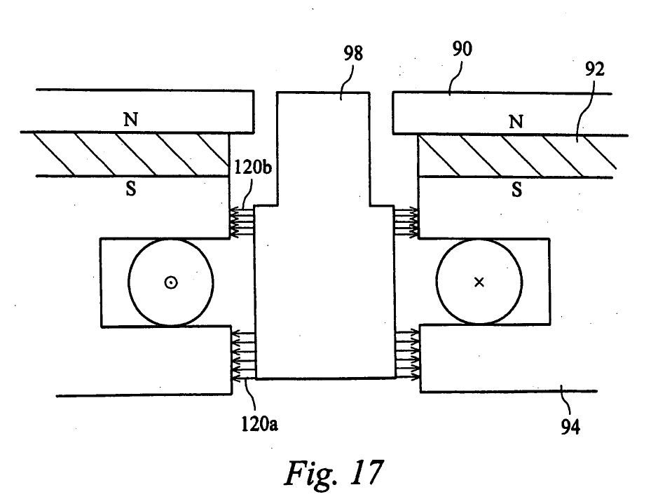

By the principle of least action, the system attempts to revert to the lowest energy state. The armature is therefore moved down in relation to the stator poles in order to minimise the active height Y₁ as depicted in FIG. 17.

By reversing the current, it is possible to deflect the armature in the opposite direction thus pushing the diaphragm and decreasing the volume of the ejection chamber.

The dimensions of the actuator are dimensioned with regard to the airgap g and the required travel t as shown in FIG. 18.

In this arrangement, the travel t of the armature defines the height of the stator pole faces x₅, x₆. Preferably, the distance x₁ is a half of x₅ as this serves to provide an equal linear movement in both of the actuation directions. It is desirable that x₁ remains within the range g≦x₁≦(x₅−g) as field edge effects begin to apply stress to the coil and reduce actuator efficiency outside this range. A clearly defined shoulder 91 serves to define the air gap spacing g and the air gap volume v. The air gap between the flux actuator and the flux actuator plate 90 is also important, hence the overhang 93. This air gap is also of the order g.

Typical dimensions are:
x₅=x₆
x₅=t+2kg
y>2g
x₃≧t/2+kg
where k will typically lie in the range 1 to 3.

It is important that the shape of the armature and the geometry of the air gap are such that the armature has a minimum energy position on excitation of the coil and that this minimum energy position is displaced in the actuation direction from the rest position. This is achieved in the described arrangement essentially through shoulder 91. A wide variety of other orientations are of course possible.

One advantage that the slotted stator or bias field magnetic actuator has over the Lorentz forms of magnetic actuator is that the force acting on the coils is weak. The coils themselves are formed as multiple coils in multiple layers and the limited size of the actuators makes the coils susceptible to damage. Thus, it is important to reduce the force acting on them.

A second advantage is that the armature mass is minimised compared to the Lorenz force types. Minimising the armature mass results in maximising the operational frequency of the droplet deposition device.

Advantageously, when compared with a variable reluctance actuator, the force developed is substantially linearly dependent on current regardless of the polarity of the current. With variable reluctance type actuators, the force is a function of the air gap and is therefore very sensitive to manufacturing tolerances. This requirement for high tolerance is reduced in the flux modulation actuator.

Looking in greater detail at the armature force, it has been found that the armature force Fₓ can be plotted as a function of the armature position. The graph for the situation where no current is flowing in the coil is given in FIG. 19.

It has been noted that there is a dead band lying approximately in the range −kg<x<+kg where the armature force Fₓ is close to zero. A field from the permanent magnet is, however, continually present but force is only applied to the armature when a current is applied to the coil. When a non zero coil current i is applied to the excitation coil, the magnetic field in the air gap ‘ab’ is distorted with the field in the slot remaining relatively weak. This field distortion generates a force on the armature.

In the case where the flux density in the air gap due to the permanent magnet is B, the coil length L and the coil has N turns, the flux linkages with the coil is 2BΔxLN when the armature moves upwards by a distance Δx in time Δt.

By the conservation of energy and the principle virtual work, the force F acting on the armature is given by
FΔX=(2BΔXLN/Δt)iΔt
So that F=2BLNi

The force of the actuator plotted as a function of the coil current is given in FIG. 20. The linear nature of the force makes this type of actuator easily controllable simply by varying the current through the coils.

FIG. 21 depicts the bias flux actuator attached to an ejection chamber through a pre-described push-rod plate. As mentioned earlier it is a requirement that the push-rod plate does not transmit rotational and bending forces from the floor of the ejection chamber to the actuator.

In the bias field actuator, the air gap spacing is important in defining the dimensions of the armature element. It is noted that, in this embodiment, the armature is fixed only at one point, namely to the channelled or push-rod components. Since the opposite end is free to move within the stator any rotational and bending forces will be transmitted to the armature. This will have a bearing on the air gap and thus the flux density within the air gap. The push-rod component serves to prevent this error.

The actuator plate component can be formed through the repeated formation and selective removal of layers. Appropriate techniques include those known as MEMS fabrication techniques.

FIG. 22 illustrates an embodiment of a planar construction of a fluid pumping apparatus. A first planar layer 302 is arranged parallel to a second planar layer 304. An actuator layer separates the two layers 302 & 304, and maintains structural integrity between them. Located in the actuator layer between layers 302 & 304 is an actuator assembly 306 and a push rod 308, which in this case serves as the armature for actuator assembly 306. The push rod is attached to layers 302 and 304 and is thereby constrained to move in an actuation direction 314. The layered construction described so far with respect to FIG. 22 is supported on substrate 310 to form a planar component generally designated by numeral 311 Substrate 310 includes a hollow 312 to allow free movement of push rod 308 in the actuation direction (indicated by arrow 314. In order that this motion may occur it can be seen that portions 303 of layer 302 are resiliently deformable. Corresponding portions 305 of layer 304 are also resiliently deformable. Also shown in FIG. 22 is a walled component 316 defining an open channel generally designated by numeral 318. Component 316 further includes a channel outlet 319, and has attached a nozzle plate 320. It can be seen from FIG. 22 that walled component 316 can be mated with planar component 311 to form a fluid pumping apparatus. Such a pumping apparatus can be operated to cause a flow of fluid from channel 318 through said outlet 319. Channel 318 may be supplied with fluid from a fluid supply (not shown).

In a preferred arrangement the armature 308, which is constrained to straight line movement by the flexible portions 303, 305 functioning as a parallelogram linkage, is subject to an electromagnetic force provided, for example, by the arrangement of FIG. 13.

FIG. 23 is a view of a channelled construction forming part of a fluid pumping apparatus. A first planar component 352 comprises a first resiliently deformable layer 354; a second resiliently deformable layer 358; and an actuator arrangement 360. Actuator arrangement 360 includes a number of armatures 362 bonded to and carried between the layers 354 and 358. The regions 356 of the layer 354 overlying the armature 352 will remain stiff, and—on actuation—will move in translation as shown on the right hand side of the figure in an actuation direction perpendicular to the plane of layer 354.

A second component 364 having channel walls 366 defining a channel 370, is arranged to be mated with component 352. In this way, the first layer 354 forms one of the channel walls of channel 370. It can be seen that channel 370 may comprise a number of regions 356 which may be acted upon by actuator arrangement 360 via armatures 362. Each armature may act upon one or more regions 356 of layer 354, and may be individually addressable. In this way a fluctuating pressure distribution may be produced in channel 370. In one embodiment it may be desirable to set up a peristaltic wave in channel 370 through sequential operation of armatures 362. In FIG. 23 the armatures are operated by a single multiply addressable actuator assembly 360, however a number or discrete actuators could also be employed in a similar fashion.

Regions 356 may be arranged in a wide variety of patterns with respect to channel 370. In FIG. 23, there is shown two rows of elongate regions (arranged parallel to the length of the channel) operable by elongate armatures running the length of the portions, and each row having two separately operable regions. In an alternative arrangement there might be provided a series of elongate regions having an elongation direction perpendicular to the channel length, the series extending along the length of the channel. Further possible patterns of regions are included in the scope of the claims.

Although a flux modulation actuator has been described as a preferred magnetic actuator, it should be understood that a number of different types of magnetic actuator could be employed in conjunction with the present invention.

FIG. 24 depicts a magnetic actuator operating according to variable reluctance force. The channelled component 42, and nozzle 44 are formed as described with reference to FIGS. 1 to 3 above.

An armature 46, is formed from an electroformed, soft magnetic material such as Nickel/Iron or a Nickel/Iron/Cobolt Alloy. The armature is designed to provide an element of spring to aid deformation and recoil.

An electroformed stator component 48 of a soft magnetic material is provided with a copper coil 50 encircling the stator core 52. In operation, a DC current is passed through the coil to generate a magnetic field that attracts the armature. The volume of the ink channel is thus increased in order to initiate an acoustic wave. At an appropriate timing, equal to ½L_{c}/c, (where L_{c} is the effective channel length and c is the speed of sound in the ink) the current is removed to allow the armature to recoil. The recoil reinforces the reflected acoustic wave in the channel and causes a droplet to be ejected from the nozzle 44.

An alternative form of variable reluctance type actuator is depicted in FIG. 25. The spring element 56 is formed as a diaphragm of etched silicon or some other other non-magnetic material. A stator 58 forms a central area through which a portion 64 of the armature 62 extends in order to be in contact with the diaphragm. A coil 60 is provided within the stator adjacent to a portion of the armature 62 having a large surface area.

Upon actuation, the armature is attracted towards the stator and thus deflects the diaphragm into the channel and causes droplet ejection from the nozzle.

FIG. 26, depicts an actuator capable of deflecting using a Lorentz force. A channelled component is formed as described earlier and the actuator component is formed as a separate component and attached to it. An etched silicon actuator plate 74 is formed with a number of holes through which a moveable armature structure is posted. A stationary coil 78 is attached to the underside (or in an alternative embodiment to the upper-side) of the etched silicon plate between the plate and the diaphragm 100.

The movable armature structure consists of two metallic extensions 76, 77 joined by a permanent magnet 84. The middle extension is posted through the annulus defined by the coil and is joined to the diaphragm 100. The outer extension extends around the coil and is shorter than the middle extension.

Application of a current to the coil interacts with the permanent magnetic field according to the Lorentz force equation and has the effect of moving the middle extension to deflect the diaphragm. This deflection results in ejection of a droplet from the nozzle.

Whilst all the previous bias flux actuators have been depicted using only a single coil layer it is possible to use two layers of coils as shown in FIG. 27. The flux from the magnet is the same whether there is one coil or two. However, the force generated by the armature can be increased by adding a second bias field from the second coil positioned on the opposite side of the magnet to the first coil.

Further preferred actuator embodiments are shown in FIGS. 28 to 31.

FIG. 28 illustrates a further alternative actuator arrangement. An armature is provided comprising a central magnetic portion 1504 and two non magnetic rigid portions 1506. The armature is constrained to move in the (generally vertical as viewed in FIG. 28) actuation direction at one end by a first planar layer 1508, and at the other end by a second layer 1510. The actuator arrangement includes a supporting substrate 1512. A permanent magnet 1514 is located beneath the substrate with polarity as indicated in the Figure. A magnetic yoke is provided to channel flux from magnet 1514, through magnetic portion 1504 of the armature, and back to the opposite pole of magnet 1514. In the region of the armature, the yoke providing flux to the armature comprises two magnetic portions 1516 and 1518, separated magnetically in the actuation direction. A similar yoke arrangement is provided to return flux passing from the armature back to permanent magnet 1514. In this way it can be seen that a permanent magnetic flux is established which, in the region of the armature, is divided into two substantially parallel flux paths, spaced apart in the actuation direction. These flux paths include air gaps 1520 and 1522 adjacent to the armature. A channel component 1524 is also shown.

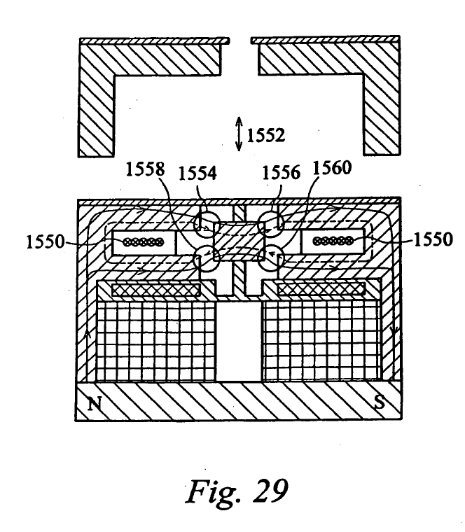

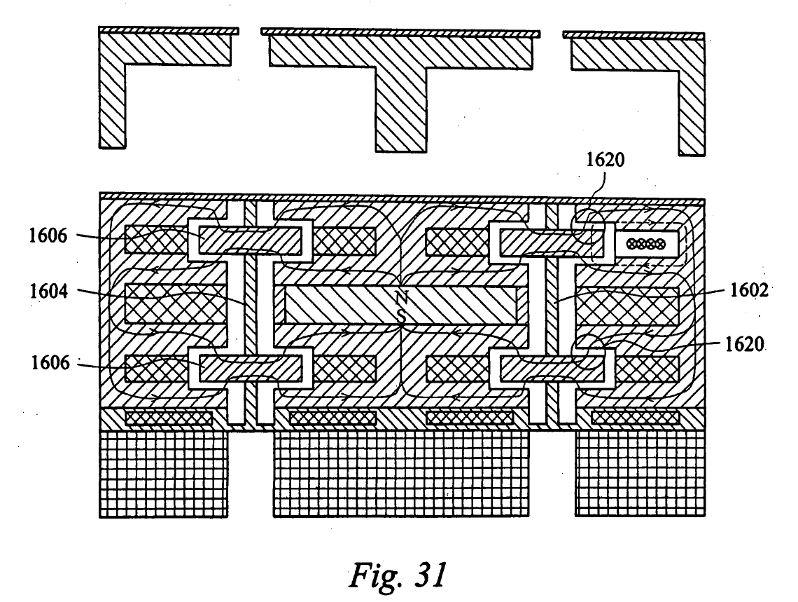

FIG. 29 depicts substantially the same actuator arrangement as in FIG. 28 but now illustrates lines of flux. It can be seen that in this arrangement the flux from the permanent magnet (shown solid line) passes through the armature substantially in a single direction, perpendicular to the direction of actuation (indicated by arrow 1552). FIG. 29 also shows excitation coils 1550, and the flux produced from said coils (shown broken line). It can be seen that this secondary flux reinforces the primary flux at flux carrying air gaps 1554 and 1556, and that it acts to reduce primary flux density at air gaps 1558 and 1560. Although the flux passing through the armature remains substantially constant, an unbalanced acts on the armature in the direction of actuation. In FIG. 29 the secondary flux has been shown forming a continuous path around both sets of coil windings 1550. Secondary flux may however also be considered to form a closed circuit around a single set of windings as shown in FIG. 31. This does not alter the principle of flux modulation providing a force in the actuation direction.

The embodiments of FIGS. 28 and 29 can advantageously be used as the basis for an actuator having multiple armatures with multiple flux carrying air gaps.

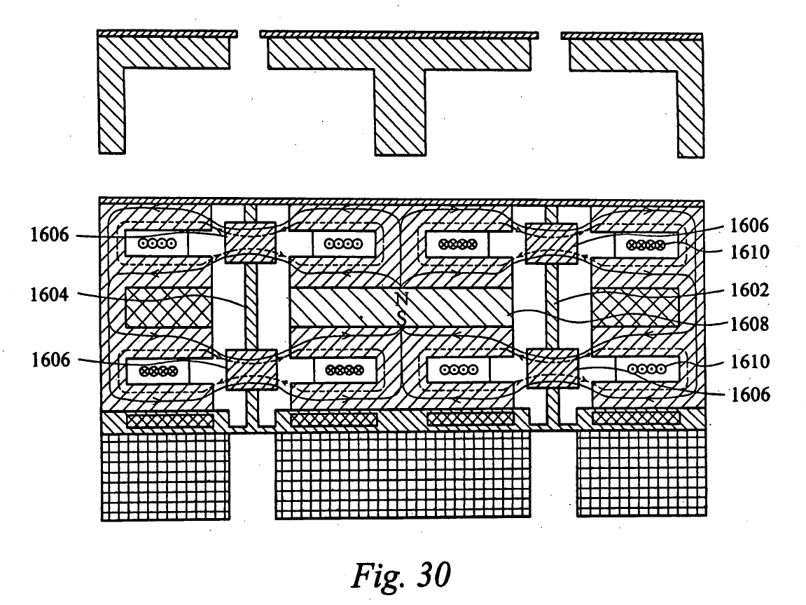

FIGS. 30 and 31 illustrate still further alternative actuator arrangements. FIG. 30 shows an actuator arrangement with two armatures 1602 and 1604, each armature having two magnetic portions 1606, and a plurality of non magnetic, supporting portions. A single primary magnet 1608 provides a primary flux (shown solid line) in two flux paths separated in the actuation direction, for each of the magnetic armature portions 1606 of the two armatures. Excitation coils 1610 are provided for each armature, arranged with the coil axis perpendicular to the actuation direction. In this way the secondary flux (shown broken line) for each armature acts to reinforce and cancel the primary flux respectively at corresponding pairs of air gaps to provide a force acting on each magnetic portion of a given armature in the actuation direction. Whilst both armatures in the figure share a permanent magnet providing primary flux, the excitation coils for each armature may be independently actuated to allow each armature to be separately operable. Although FIG. 30 shows the two actuators acting on separate channels, they could of course operate on the same channel, spaced in the width, or in the length of channel, operating in unison or in a peristaltic or other cooperative manner.

FIG. 31 illustrates a variation on the embodiment of FIG. 30. There is again shown an actuator arrangement with two armatures 1602 and 1604, each armature having two magnetic portions 1606, and a plurality of non magnetic portions. Here however, the magnetic portions of the armatures extend and laterally overlap with the yoke in regions surrounding the flux carrying air gaps 1620 (only two such air gaps are shown in the figure). This results in primary flux (shown solid line) in the air gaps having a direction substantially parallel to the actuation direction. The same is true also for the secondary flux (shown broken line) caused by the excitation coils (only one part of the secondary coils has been shown for simplicity). This embodiment is advantageous in that the area of the flux carrying air gaps perpendicular to the flux direction can be greater than in a corresponding embodiment having air gap flux passing in a direction perpendicular to the actuation direction. This enables a greater actuation force to be generated. This embodiment has further advantage in an actuator arrangement formed of a series of parallel layers, each layer being orthogonal to the direction of actuation of the actuation device. In this case, the thickness of the air gap is controlled by layer deposition thickness. The thickness of an air gap formed in this orientation can therefore be more accurately defined than that of an air gap in an orientation as shown in FIG. 28 for example, in which the air gap tolerance would be controlled by mask registration.

It should be understood that embodiments of the invention wherein the magnetic portion of the armatures laterally overlap with the yoke in the regions surrounding the flux carrying air gaps, are not limited to the particular example described above. Such a feature could equally be usefully applied to other embodiments of actuator arrangements.

There will now be described an example of a MEMS manufacturing process, with reference to FIGS. 32 to 40. The example is taken of the manufacture of the structure shown in FIG. 21.

In FIG. 32, a patterned photo resist 120 is deposited onto the resiliently deformable pusher-rod plate 100 of FIG. 21. Subsequently a layer of electroformed nickel alloy 122 is deposited. The nickel alloy will form the first part of the armature and a support for the stator. The photoresist, once removed will form an air gap.

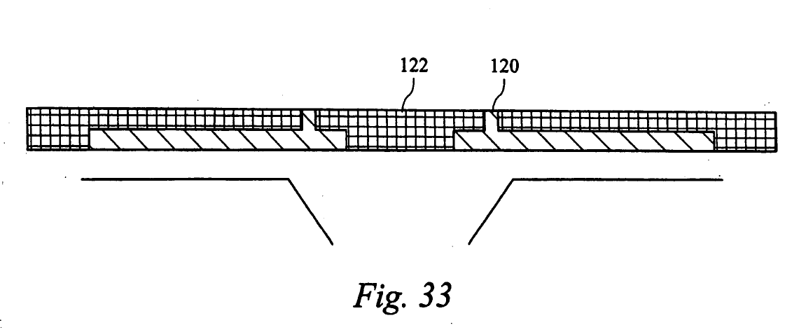

Once the first layer of FIG. 32 is completed, a subsequent layer of photoresist and metal alloy is similarly deposited as shown in FIG. 33. These steps may repeated a number of times until the desired structure is achieved.

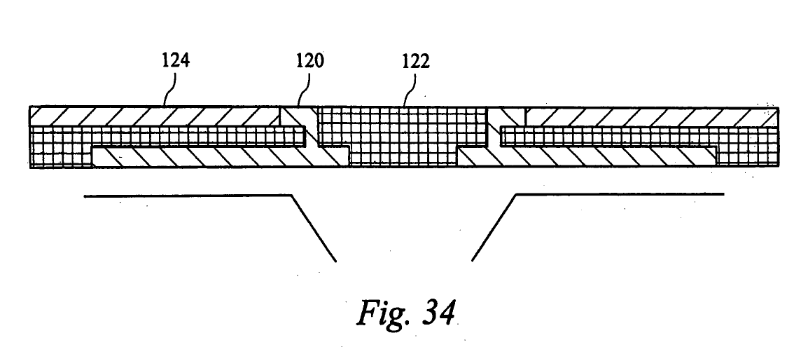

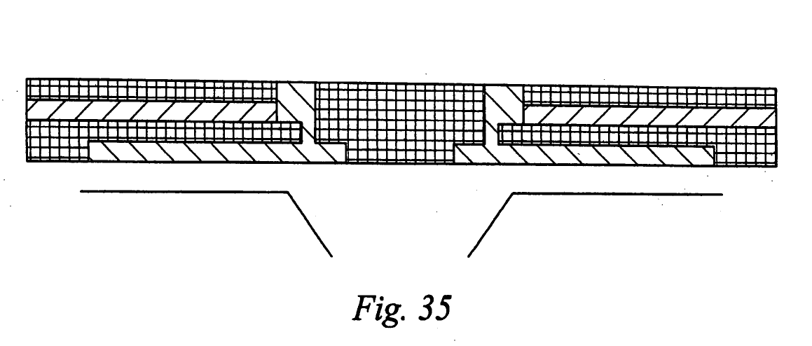

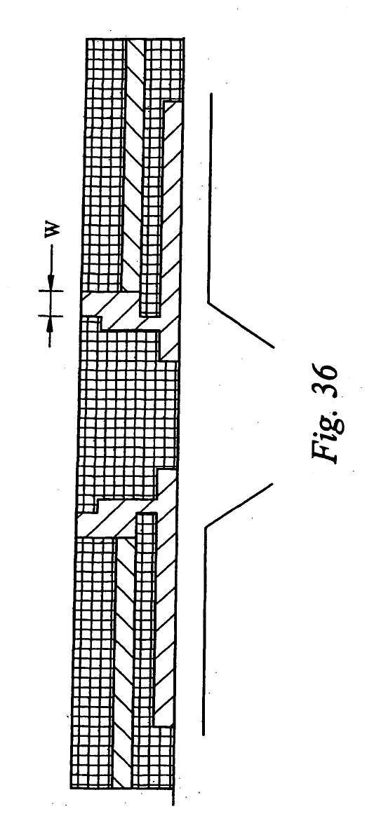

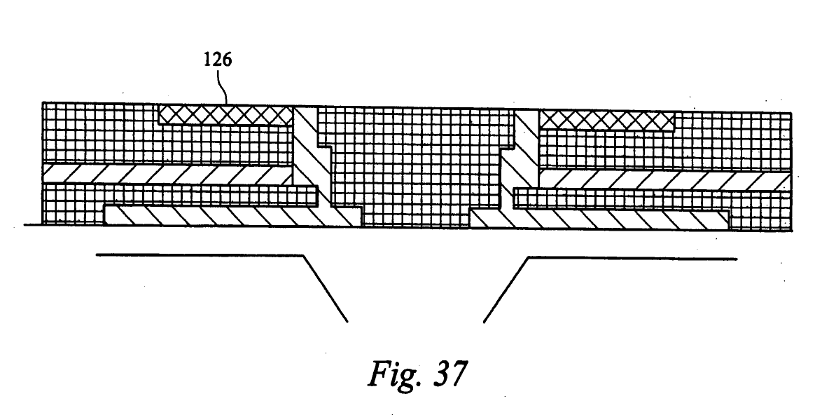

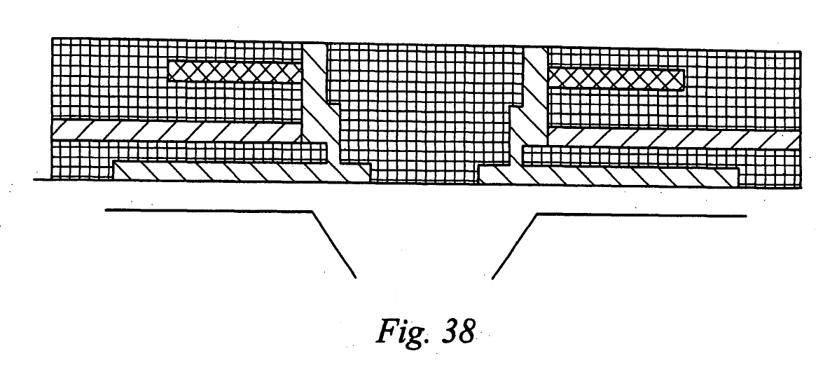

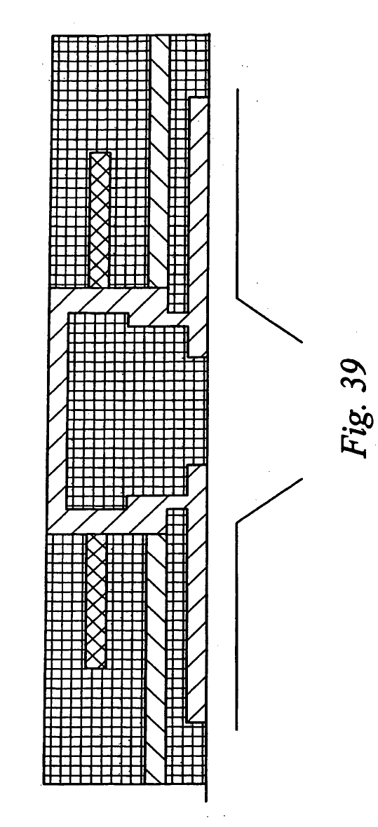

In FIG. 34, a layer is formed in which a permanent magnet 124 is deposited along with the photoresist 120 and the electroformed alloy 122. Further layers of alloy and photoresist are deposited in FIGS. 35 and 36. It can be seen that in FIGS. 35 and 36 the profile of a flux carrying air gap is developed. In this particular example the width of the air gap W shown in FIG. 36, is controlled by mask registration in the deposition process. At a certain depth, a layer comprising electrical coils 126 is deposited as shown in FIG. 37. As multiple layer coils are preferred, this layer may be repeated a number of times. A number of connections and vias may be incorporated into some or all of the layers to allow for electrical connection of the coils. More layers of photoresist and metal alloy are deposited in FIGS. 38 and 39.

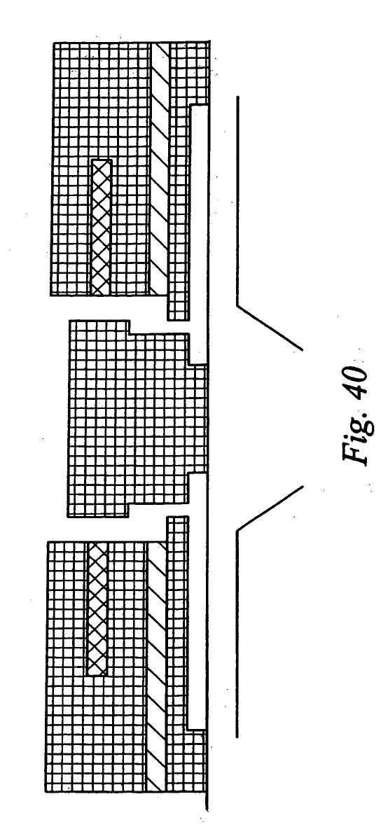

Finally, in FIG. 40, the photoresist is removed from the whole construction separating the armature from the remainder of the structure.

Some of the particular embodiments described refer to drop on demand ink jet apparatus, however the invention may find application in a wide variety of fluid pumping applications. Particularly suitable applications include so called “lab-on-chip” applications and drug delivery systems. The invention is also applicable to other droplet deposition applications such as apparatus to create aerosols.

Micro-Electro-Mechanical-System techniques have been discussed as suitable for manufacture of apparatus according to the present invention. MEMS techniques include Deep Reactive Ion Etching (DRIE), electroplating, electrophoresis and Chemical-Metal Polishing (CMP). Examples of general MEMS techniques are discussed in textbooks of which the following are examples:

P. Rai-Choudhury, ed., Handbook of Microlithography, Micromachining, and Microfabrication, Vol 1 and Vol 2, SPIE Press and IEE Press 1997, ISBN 0-8529-6906-6 (Vol 1) and 0-8529-6911-2 (Vol 2)

Mohamed Gad-el-Hak, ed., The MEMS Handbook, CRC Press 2001, ISBN 0-8493-0077-0

Both magnetic and non magnetic materials are used in the present invention. Suitable materials for use in construction include Si-based compounds, Nickel and Iron based metals including Ni—Fe—Co-Bo alloys, Polyimide, Silicone rubber, and Copper and Copper alloys. A useful review of magnetic materials suitable for use with MEMS techniques (and incorporated herein by reference) is to be found in:
J. W. Judy, N. Myung, “Magnetic Materials for MEMS”, MRS workshop on MEMS materials, San Francisco, Calif. (Apr. 5-6, 2002) pp. 23-26.

Although embodiments have been shown having particular numbers of channels, actuators and armatures, it should be understood that large arrays of channels and actuators can be manufactured on a single substrate, and that arrays of channels can be butted together.

Whilst embodiments have been described with respect to linear channels. It would be equally possible to utilise other chamber architectures including, but not exclusively, architectures where the acoustic wave travels radially of the nozzle as described with regard to WO 99/01284 the contents of which are incorporated herein.

Each feature disclosed in this specification (which term includes the claims) and/or shown in the drawings may be incorporated in the invention independently of other disclosed and/or illustrated features. component is through the repeated formation and selective removal of layers.

1. Droplet deposition apparatus according to claim 3, further comprising an ejection nozzle connected with the chamber; a liquid supply providing for continuous flow of liquid through the chamber; acoustic boundaries serving to reflect acoustic waves in the liquid of the chamber; and an actuator remote from the chamber and the liquid supply, acting in said actuation direction upon said resiliently deformable chamber wall to create acoustic waves in the liquid of the chamber and thereby cause droplet ejection through said nozzle.

2. Apparatus according to claim 1, wherein said acoustic boundaries serve to negatively reflect acoustic waves in the liquid of the channel.

3. Fluid pumping apparatus comprising chamber walls defining a fluid chamber, one of said chamber walls being resiliently deformable in an actuation direction; a chamber outlet; and an actuator remote from the chamber, acting in said actuation direction upon said resiliently deformable chamber wall to create acoustic waves in the chamber and thereby cause fluid flow in the chamber outlet.

4. Apparatus according to claim 3, wherein said resiliently deformable chamber wall forms a seal isolating the actuator from fluid in the chamber.

5. Apparatus according to claim 3, wherein said fluid chamber comprises an elongate liquid channel, and wherein said resiliently deformable chamber wall comprises an elongate channel wall.

6. Apparatus according to claim 3, wherein said resiliently deformable chamber wall comprises a substantially rigid element capable of transmitting force from the actuator to fluid in the channel and at least one first flexure element.

7. Apparatus according to claim 6, wherein said resiliently deformable chamber wall comprises an elongate channel wall and said at least one flexure element extends substantially across the full width of the channel wall.

8. Apparatus according to claim 6, wherein said resiliently deformable chamber wall comprises an elongate channel wall and said at least one flexure element extends across a portion of the width of the resiliently deformable channel wall.

9. Apparatus according to claim 6, wherein said resiliently deformable chamber wall comprises an elongate channel wall and said rigid element extends along the length of the channel.

10. Apparatus according to claim 6, wherein said resiliently deformable chamber wall comprises a plurality of flexure elements arranged to constrain movement of the rigid element to said actuation direction.

11. Apparatus according to claim 10, wherein at least one of said flexure elements contacts fluid in the channel and is stiff with respect to fluid pressure.

12. Apparatus according to claim 10, wherein said flexure elements are arranged in a parallelogram linkage with respect to the rigid element.

13. Apparatus according to claim 6, wherein the actuator comprises a push-rod acting on said rigid element.

14. Apparatus according to claim 13, wherein the push-rod is carried on said rigid element.

15. Apparatus according to claim 13, wherein the push-rod serves as the armature in an electromagnetic actuator arrangement.

16. Apparatus according to claim 13, further comprising support means connected to the push rod at a location spaced apart from said rigid element in the actuation direction, wherein said support means constrains movement of said push rod to the direction of actuation.

17. Apparatus according to claim 16, wherein said support means comprises one or more second flexure elements connected to said push rod at a location spaced apart from said rigid element, said first and second flexure elements arranged to act like a parallelogram linkage with respect to the push rod.

18. Apparatus according to claim 3, wherein the actuator operates electromagnetically.

19. Apparatus according to claim 15, wherein the actuator comprises an armature displaced through modulation in flux distribution.

20. Apparatus according to claim 1, comprising a first planar component comprising a plurality of rigid channel walls corresponding with a set of channels; and a plurality of nozzles aligned with said channels; and a second planar component disposed parallel with the first planar component, the second planar component comprising a plurality of actuators aligned with said channels.

21. Apparatus according to claim 20, wherein said set of channels are elongate and arranged parallel to one another.

22. Apparatus according to claim 20, wherein the first planar component further comprises a resiliently deformable channel wall for each channel.

23. Apparatus according to claim 20, wherein the second planar component further comprises a resiliently deformable channel wall for each channel.

24. Apparatus according to claim 20, wherein said first component is integral.

25. Apparatus according to claim 20, wherein said first component is manufactured by a process comprising the step of etching away material to define the channel walls.

26. Apparatus according to claim 20, wherein the channel walls are formed by machining.

27. Apparatus according to claim 20, wherein the channel walls are formed by electroforming.

28. Apparatus according to claim 20, wherein said first component is formed from silicon.

29. Apparatus according to claim 20, wherein said second component is a laminate manufactured through the repeated formation and selective removal of layers.

30. Apparatus according to claim 29, wherein each layer comprises more than one material.

31. Apparatus according to claim 3, wherein at least one distinct region is defined in the resiliently deformable chamber wall, with the or each region being movable in translation in the actuation direction through resilient deformation of the wall, the or each said region being stiff.

32. Apparatus according to claim 31, wherein there exist two or more said regions.

33. Apparatus according to claim 32, wherein one or more of said regions is actuatable independently of another region.

34. Apparatus according to claim 32, wherein the actuator acts upon more than one region.

35. Apparatus according to claim 32, comprising a plurality of like actuators associated respectively with said regions.

36. A generally planar component for use in fluid pumping apparatus comprising:
a first planar layer having resiliently deformable portions;
a second planar layer parallel to said first layer having corresponding resiliently deformable portions; and
a plurality of actuators having an actuation direction, located between said two layers and connected to interior surfaces of said two layers with the direction of actuation orthogonal to the two layers;
wherein said actuators are operable to deform selected resiliently deformable portions of said first and second layers in an actuation direction so as to cause a change in pressure of a liquid in contact with the exterior of said first planar layer.

37. A generally planar component according to claim 36, wherein said first planar layer is impermeable.

38. A generally planar component according to claim 36, wherein said second planar layer is permeable.

39. A generally planar component according to claim 36, wherein said actuators comprise rigid push rods connected between corresponding resiliently deformable portions of said first and second planar layers.

40. A generally planar component according to claim 39, wherein said push rods are constrained by said first and second planar layers to move only in the direction of actuation.

41. A generally planar component according to claim 39, wherein said push rods serve as the armature in an electromagnetic actuator arrangement.

42. A generally planar component according to claim 36, wherein said resiliently deformable portions of one layer each have a direction of elongation, the directions of elongation being parallel.

43. A method of constructing a fluid pumping apparatus comprising the steps of:
forming a first planar component according to claim 36;
forming a second planar component comprising a plurality of rigid channel walls defining open sided channels corresponding to the resiliently deformable portions of said first planar component; and
mating the two planar components such that they are parallel and such that the channels of the second planar component are aligned with the resiliently deformable portions of the first planar component, which thus form part of a resiliently deformable channel wall.

44. A method according to claim 43, wherein the first planar component comprises one resiliently deformable portion for each channel.

45. A method according to claim 43, wherein the first planar component comprises more than one resiliently deformable portion for each channel.

46. Fluid pumping apparatus comprising elongate channel walls defining an elongate fluid channel, the channel having a fluid outlet, one of said channel walls having at least one distinct region movable in translation in an actuation direction orthogonal to the length of the channel and at least one straight line actuator acting in said actuation direction upon said region of the channel wall to create an acoustic wave in the channel and thereby expel fluid from said outlet.

47. Apparatus according to claim 46, wherein said straight line actuator comprises an armature movable bodily under electromagnetic force in a straight line in the actuation direction.

48. Apparatus according to claim 47, wherein said armature is constrained to movement in said straight line.

49. Apparatus according to claim 49, wherein said armature is constrained by elements functioning as a parallelogram linkage.

50. Apparatus according to claim 46, wherein said region is elongate and extends along a substantial portion of the acoustic length of the channel.

51. Apparatus according to claim 46, wherein there are provided at least two said regions.

52. Apparatus according to claim 51, wherein the actuator acts upon more than one region.

53. Apparatus according to claim 52, comprising a plurality of like actuators associated respectively with said regions.

54. Apparatus according to claim 46, wherein said fluid outlet comprises a droplet deposition nozzle.

55. Apparatus according to claim 46, comprising a plurality of like channels each having a respective actuator, the actuators having parallel actuation directions.

56. Apparatus according to claim 46, in the form of an ink jet printer.

57. Droplet deposition apparatus comprising a liquid chamber capable of sustaining acoustic waves traveling in the liquid, a droplet ejection nozzle positioned for the ejection of a droplet in response to said acoustic waves and an electromagnetic actuator serving on receipt of an electrical drive signal to create an acoustic wave in the chamber and thereby effect droplet ejection.

58. Droplet deposition apparatus according to claim 57, wherein the actuator is remote from the chamber.

59. Droplet deposition apparatus according to claim 57, wherein the chamber is defined by chamber walls, one of said chamber walls being resiliently deformable in the actuation direction under the action of said actuator.

60. Droplet deposition apparatus according to claim 59, wherein said resiliently deformable chamber wall forms a liquid seal isolating the actuator from liquid in the chamber.

61. Droplet deposition apparatus according to claim 57, further comprising acoustic boundaries serving to reflect acoustic waves in the liquid of the chamber.

62. Droplet deposition apparatus according to claim 57, further comprising a liquid supply providing for continuous flow of liquid through the chamber.

63. Droplet deposition apparatus according to claim 57, wherein the actuator comprises an armature displaced through modulation in distribution of a magnetic flux of substantially constant magnitude.

64. Droplet deposition apparatus according to claim 57, wherein said liquid chamber comprises an elongate liquid channel

65. Droplet deposition apparatus according to claim 64, wherein the actuator operates in an actuation direction orthogonal to the channel length.

66. Droplet deposition apparatus according to claim 64, wherein the actuator extends along substantially the length of the channel.

67. Droplet deposition apparatus according to claim 64, comprising acoustic boundaries at respective opposing ends of the channel.

68. Droplet deposition apparatus according to claim 64, wherein the ejection nozzle is connected with the channel at a point intermediate its length.

69. Droplet deposition apparatus according to claim 64, comprising a first planar component comprising a plurality of rigid chamber walls corresponding with a set of chambers; and a plurality of nozzles aligned with; said chambers; and a second planar component disposed parallel with the first planar component, the second planar component comprising a plurality of actuators aligned with said chambers.

70. Droplet deposition apparatus according to claim 69, wherein the first planar component further comprises a resiliently deformable chamber wall for each chamber.

71. Droplet deposition apparatus according to claim 69, wherein the second planar component further comprises a resiliently deformable chamber wall for each channel.

72. Droplet deposition apparatus according to claim 69, wherein said first component is integral.

73. Droplet deposition apparatus according to claim 69, wherein said first component is manufactured by a process comprising the step of etching away material to define the chamber walls.

74. Droplet deposition apparatus according to claim 69, wherein the chamber walls are formed by machining.

75. Droplet deposition apparatus according to claim 69, wherein the chamber walls are formed by electroforming.

76. Droplet deposition apparatus according to claim 69, wherein said first component is formed from silicon.

77. Droplet deposition apparatus according to claim 69, wherein said second component is a laminate manufactured through the repeated formation and selective removal of layers.

78. Droplet deposition apparatus according to claim 77, wherein each layer may comprise more than one material.

79. Droplet deposition apparatus comprising an elongate liquid channel bounded in part by a resiliently deformable diaphragm; a liquid supply for the channel; an ejection nozzle communicating with the channel; and a push-rod which is separated from the liquid by the diaphragm, the push-rod being displaceable in an actuation direction orthogonal to the length of the channel to deform the diaphragm to displace liquid in the channel and thereby cause droplet ejection through said nozzle, wherein the push-rod is supported by at least one flexural element at two locations spaced one from the other in the actuation direction.

80. Droplet deposition apparatus according to claim 79, wherein the push-rod is constrained by said at least one flexural element against rotation about an axis parallel to the length of the channel.

81. Droplet deposition apparatus according to claim 79, wherein the push-rod is supported by at least one flexural element at each said location, the flexural elements serving as a parallelogram linkage.

82. Droplet deposition apparatus according to claim 79, wherein the diaphragm serves as one said flexural element.

83. Droplet deposition apparatus according to claim 79, wherein the push-rod is integral with the diaphragm.

84. Droplet deposition apparatus according to claim 79, wherein the nozzle opposes the diaphragm in the actuation direction.

85. Droplet deposition apparatus according to claim 79, wherein the diaphragm extends along the length of the channel.

86. Droplet deposition apparatus according to claim 79, wherein at least one of said flexure elements contacts liquid in the channel and is stiff with respect to liquid pressure.

87. Droplet deposition apparatus according to claim 79, wherein the push-rod communicates at end remote from the diaphragm with an actuator.

88. Droplet deposition apparatus according to claim 87, wherein the actuator comprises an electromagnet actuator.

89. Droplet deposition apparatus according to claim 79, wherein the push-rod serves as the armature in an electromagnetic actuator.

90. Droplet deposition apparatus according to claim 88, wherein the actuator comprises an armature displaced through modulation in flux distribution.

91. Droplet deposition apparatus according to claim 79, further comprising acoustic boundaries at respective opposing ends of the channel serving to reflect acoustic waves in the liquid of the channel; deformation of the diaphragm by the push-rod serving to create acoustic waves in the liquid of the channel and thereby cause droplet ejection through said nozzle.

92. A method of manufacturing droplet deposition apparatus, having a first planar component comprising a plurality of rigid channel walls corresponding with a set of parallel channels; a resiliently deformable channel wall for each channel, said resiliently deformable channel walls lying in a common plane; and a second planar component comprising a linear actuator for each channel, said actuators having respective actuation directions which are parallel; the resiliently deformable channel walls lying between and in a parallel relationship with the first and second planar components in the manufactured apparatus, with said actuation direction disposed orthogonal to said common plane and the actuators serving to actuate the respective channels through deformation of the associated resiliently deformable channel walls.

93. A method according to claim 92, wherein the step of forming the first planar component comprises the step of forming a planar wafer and etching away material from one planar face of the wafer to define the channel walls.

94. A method according to claim 93, wherein the step of forming the first planar component further comprises the step of etching away material from the other planar face of the wafer to define the resiliently deformable channel walls.

95. A method according to claim 94, wherein the step of forming the first planar component comprises the step of depositing material after etching away material from said one planar face, the step of etching away material from the other planar face of the wafer serves define a layer of said deposited material as a resiliently deformable channel wall.

96. A method according to claim 94, wherein step of etching away material from the other planar face of the wafer to define the resiliently deformable channel walls serves to leave for each channel a push-rod connected with the associated resiliently deformable channel wall.

97. A method according to claim 96, wherein each pushrod extends along substantially the length of the associated channel.

98. A method according to claim 96, wherein the step of forming the first planar component comprises the further step of forming an interaction layer bonded to the respective free ends of the push rods.

99. A method according to claim 92, comprising forming said wafer from silicon.

100. A method according to claim 93, wherein etching step comprises deep reactive ion etching.

101. A method according to claim 95, comprising forming said wafer from silicon and wherein said deposited material comprises SiO₂ or SiN.

102. A method according to claim 92, comprising forming said second component through repeatedly forming and selectively removing layers.
